(19) United States
(12) Patent Application Publication
(10) Pub. No.: US 2009/0045136 A1
(43) Pub. Date: Feb. 19, 2009

(54) METHOD FOR ADSORPTION OF METAL AND AN ADSORPTION MATERIAL DIRECTED THERETO AND METHOD FOR RE-USE OF THE ADSORPTION MATERIAL

(76) Inventor: Rob Hellingwerf, Goteborg (SE)

Correspondence Address: MANELLI DENISON & SELTER, 2000 M STREET NW SUITE 700, WASHINGTON, DC, 20036-3307, US

(21) Appl. No.: 11/817,705

(22) PCT Filed: Mar. 3, 2006
(86) PCT No.: PCT/SE06/50021

§ 371 Date: May 27, 2008

(30) Foreign Application Priority Data
Mar. 4, 2005 (SE) 0500505-3

(51) Int. Cl. B01D 15/36; C01B 33/24; C01B 33/32; C01D 7/00; B01J 20/10

(52) U.S. Cl. 210/682; 210/681; 210/688; 210/687; 423/331; 423/332; 423/421; 423/430; 428/402; 502/407

(57) ABSTRACT

The invention relates to a combined process for the adsorption of metals in a liquid and for the neutralisation of metal-containing waste acids. The adsorption material used in the process is in the form of a geological mineral containing at least one alkali metal and/or alkaline earth metal, e.g. wollastonite (CaSiO₃) , magnesite (MgCO₃) or burnt magnesite (MgO). The spent adsorption material that has been used in the adsorption process is thereafter used as neutralisation agent for the neutralisation of waste acids, such as spent pickling baths. The application moreover relates to an adsorption material comprising a geological mineral containing at least one alkali metal and/or alkaline earth metal, which mineral has been concentrated by crushing, milling and shake sieving in a dry state.

### TECHNICAL FIELD

The present invention relates to a method for the adsorption of metals in a liquid, the method comprising providing an aquatic liquid that contains particles, atoms and/or ions of at least one metal, providing an adsorption material in the form of a geological mineral containing at least one alkali metal and/or alkaline earth metal, providing a first container that comprises at least one liquid inlet, arranging said adsorption material in said container to form a first filter bed that at least partly consists of said adsorption material, supplying said liquid to the container such that at least a portion of said aquatic liquid is brought in direct contact with said adsorption material, whereby at least a part of the content of said alkaline earth metal in the adsorption material is dissolved in said aquatic liquid, and removing said aquatic liquid from the container.

The invention also relates to an adsorption material intended for the method.

The invention moreover relates to a method for the neutralisation of metal-containing, spent acids or waste acids while producing useful residual products, the neutralizing agent comprising an adsorption material according to the invention that has previously been used for metal adsorption in an adsorption process according to the invention.

### PRIOR ART

Metals, particularly heavy metals, that are spread into nature in one way or another, constitute a serious environmental problem. Leachate flows from dump heaps and old mines are examples of water flows that are difficult to control and that contain heavy metals. In the steel and metal industry, metal-containing slags are formed and dumped. Acids are furthermore used in pickling processes in order to remove oxide layers on hot-worked steel products. The spent pickling liquids are post-treated inter alia by precipitation reactions, thereby producing a metal-containing sludge that is dumped. Leachates from slag and sludge landfills constitute another environmental problem. Various industrial process waters, e.g. in the textile industry, often need purification to remove metals. Also drinking water may need purification from various metals, for health reasons.

Accordingly, there is a desire to reduce the content of metals in a number of liquids, in order to decrease the discharge of metals into nature. It is known for this purpose to use geological minerals of various types. It is disclosed in an article published in Journal of Geochemical Exploation 62 (1998), 217-227, “Northern Greece's industrial minerals: production and environmental technology developments” by Nikos Arvanitidis, that minerals are widely used in a number of industrial processes. Section 3.18 states e.g. that wollastonite is useful to control heavy metals.

Geological minerals are also used to neutralise acid liquids. Commercial processes for neutralisation of acids generate waste products in the form of sludge loaded with heavy metals, which sludge is dumped in landfills. Often, the neutralisation agent is dolomite, CaMg(CO₃)₂, but also olivine, Mg₂SiO₄, has been tested. The waste products are dumped in the form of pressed digested sludge with very high contents of inter alia Cu, Zn, Cr and Ni. From p. 223, section 3.10, in the above mentioned article, it is clear that magnesite is used to neutralise acidic mine leachates. Section 3.12 states that olivine has been successfully tested as a neutralisation agent for acidic waste liquids. Recoverable residual products can be produced in the form of silica gel, magnesium sulphate and magnetite.

A method for the neutralisation by olivine of a sulphuric acid containing heavy metals is known from U.S. Pat. No. 4,707,348. By a process in an oxidizing atmosphere, there can be obtained a silica gel that inter alia contains iron oxide and magnesium sulphate, as well as a liquid that inter alia contains magnesium sulphate. By a process in a reducing atmosphere, there is instead obtained a silica gel that inter alia contains iron sulphate and magnesium sulphate, as well as a liquid that contains iron and magnesium.

A kinetic model that describes the neutralisation of sulphuric acid with olivine is known from another article, “Olivine dissolution in sulphuric acid at elevated temperatures—implications for the olivine process, an alternative waste acid neutralizing process”, by Jonckbloedt. It discloses an empirical formula that includes temperature, grain size and amount of olivine. The formula was validated for Norwegian olivine having grain sizes in the range between 63 and 300 μm, at temperatures between 60 and 90° C.

### BRIEF ACCOUNT OF THE INVENTION

It is an object of the present invention to provide a method for the adsorption of metal particles, atoms and/or ions in a liquid, which is achieved by a method comprising the following process steps:
a) providing an aquatic medium that contains particles, atoms and/or ions of at least one metal and/or light metal and/or heavy metal,
b) providing an adsorption material in the form of a geological mineral containing at least one alkali metal and/or an alkaline earth metal,
c) providing a first container that comprises at least one liquid inlet,
d) arranging said adsorption material in said container to form a first filter bed that at least partly consists of said adsorption material,
e) supplying said liquid to the container such that at least a portion of said liquid is brought in direct contact with said adsorption material, whereby at least a part of the content of said alkali metal and/or alkaline earth metal in the adsorption material is dissolved in said liquid,
f) removing said liquid from the container, the method being characterised in that said metal particles, atoms and/or ions in the aquatic medium are at least partly adsorbed by the adsorption material.

It is furthermore an object of the invention to provide an adsorption material intended to be used in an adsorption process according to the invention, which is achieved by an adsorption material comprising at least one geological mineral that contains at least one alkali metal and/or alkaline earth metal. Suitably, the adsorption material is a mineral that comprises carbonates or silicates of magnesium and/or calcium, preferably magnesite (MgCO₃) or wollastonite (CaSiO₃), characterised in that said mineral is concentrated by crushing, milling and shake sieving in a dry condition. According to one embodiment of the invention, the adsorption material is constituted by dead burnt magnesite (MgO).

It is yet another object of the invention to find a field of applications for the spent adsorption material, enabling handling of the adsorbed metals. This is achieved by re-using the spent adsorption material as a neutralising agent for acids, whereby the adsorption material and the heavy metals adsorbed therein are dissolved. Such acids can be industrial waste acids that may contain metals and/or heavy metals, e.g. spent pickling baths, and this is achieved by a method that comprises the following process steps:
a) supplying said adsorption material to a reaction vessel,
b) supplying an acid to said reaction vessel, whereby at least a portion of said acid is brought in direct contact with said adsorption material,
c) dissolving at least a part of the adsorption material and/or said metal content of the adsorption material, while neutralising the acid and forming one or more reaction products between the acid and the adsorption material, the metals adsorbed in the adsorption material being concentrated in one or more of the reaction products,
d) recovering the reaction products.

Thanks to the invention, waste acids that may be metal loaded can be neutralised in a process in which the neutralising agent at least partly consists of the geological filter mass that has served as a metal adsorbent during the filtration process. In the neutralisation process, a number of reaction products are formed, of which at least some constitutes a recoverable commercial product. The metals that initially are in the filter mass and optionally also in the acid are being concentrated and can be handled by different means.

### BRIEF DESCRIPTION OF THE DRAWINGS

In the following, the invention will be described in greater detail with reference to the attached drawing figures, of which:

FIG. 1 shows a schematic flowchart of an adsorption process,

FIG. 2 shows an explanatory sketch over a filter column,

FIG. 3a-c shows a diagram from an adsorption test,

FIG. 4a-c shows a diagram from an adsorption test,

FIG. 5a-c shows a diagram from an adsorption test,

FIG. 6a-b shows a diagram from an adsorption test,

FIG. 7a-c shows a diagram from an adsorption test,

FIG. 8a-d shows a diagram from an adsorption test, and

FIG. 9 shows a diagram from a long period adsorption test.

### DETAILED DESCRIPTION OF THE INVENTION

The Process for Adsorption of Metals

According to the invention, industrial minerals can be converted into environmental technological materials for use as adsorption materials for metals in various liquids. By a method according to the invention, metals, light metals and/or heavy metals can be adsorbed by a physical reaction between an aquatic medium and an adsorption material according to the invention produced from such industrial minerals. By the term “industrial minerals” is intended industrial minerals and species of stone that are recovered for some other purpose than to be used for their content of metal or their heat value.

By a method according to the invention, for the concentrating of geological minerals, an adsorption material can be obtain that can be used in a device according to the invention, for the adsorption of metals from aquatic media, by employment of a process according to the invention. One field of application for the invention can be for adsorption of various metals from leachate flows in drainage basins around dump heaps and old mines. It should be understood that also light metals and heavy metals are comprised in the term “metals”. Another field of application can be adsorption of metals from refuse dump leachates etc. Yet another field of application can be adsorption of metals from metal-containing process waters.

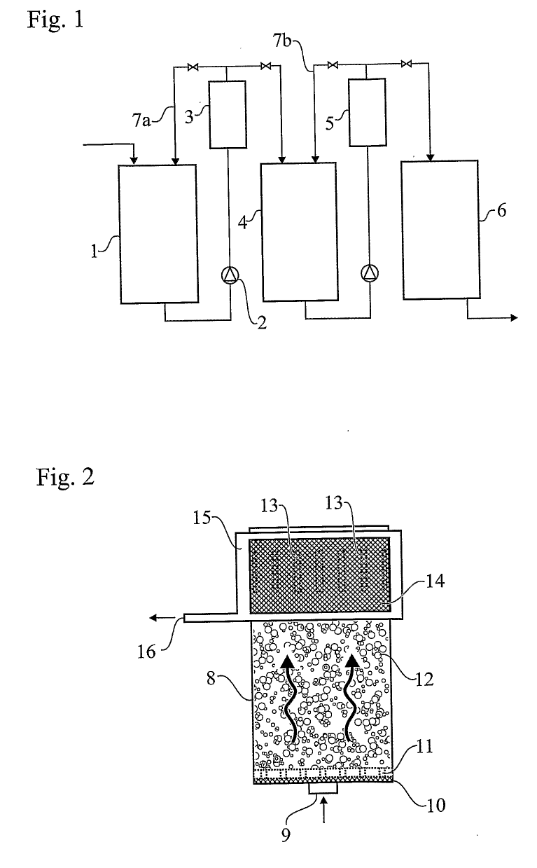

FIG. 1 shows a schematic flow chart over an adsorption process according to the invention, in an embodiment that allows for continuous operation. A metal-containing liquid flows into a first storage tank 1 and a pump 2 transports the liquid from the first storage tank to a first filter column 3 that comprises a first filter bed that at least partly consists of an adsorption material according to the invention. The metal-containing liquid is brought to flow through the filter bed and further into a second storage tank 4.

According to the concept of the invention, the dwell time for the liquid in the first filter column can be adapted such that an adequate degree of adsorption is achieved after one filter column only. It may however be suitable to arrange a several filter columns in a series, and hence the figure shows a second filter column 5 that comprises a second filter bed as well as an additional storage tank 6. The second filter bed can be composed to adsorb additional contents of the same species as the first filter bed, or be composed to adsorb other metals than the first bed. Accordingly, the composition of the geological material can be varied depending on which metal(s) that is/are desired to be adsorbed and to which degree of adsorption. Hence, the invention comprises an arrangement of several filter columns in a series, with different combinations of geological minerals in the filter beds, in order thereby to adapt the adsorption process to the metal content in the respective flow to be taken care of. By also providing the process with storage tanks between each filter column, the dwell time can be varied in the different filter columns by recirculation of the entire or a part of the liquid flow, which is indicated by conduits 7a and 7b in the figure, but it is realised that the invention also comprises an embodiment with several filter columns in a series, without intermediate storage tanks.

FIG. 2 shows an explanatory sketch over a filter column. The filter column consists of a container 8 in which the filter bed is arranged. In the bottom of the container, there is an inlet 9 for the metal-containing liquid. A filter 10 and a perforated plate 11, on top of which the filter bed 12 is arranged, are arranged in connection with the inlet. An outlet 13 for the metal-containing liquid is arranged in connection with the upper end of the container, here in the form of a number of slots. A filter 14 is arranged outside the outlet in order to prevent small particles from the adsorption material to be brought along with the liquid passing out from the container. The outlet 13 and the filter 14 are enclosed by a collecting vessel 15 at the bottom of which at least one pipe connection 16 is arranged.

From the tests performed, which are described further below, it has proven advantageous to bring the filter mass to move once in a while in order to maintain a high degree of adsorption. The reason for this can not be explained, but a phenomenon that has been noted is that a new phase seems to form in the cavities between the fragments of the filter mass. It has not been made clear today what this phase consists of, but tests have shown that a good flow and a high degree of adsorption can be maintain by bringing the filter mass to move once in a while. One way of achieving this is to control the velocity of the flow in the container and thereby to achieve a turbulent flow that results in such a movement of the material. Another way is to design the filter column such that it is movable, which can be achieved for example by arranging the suspension of the filter column such that it can rotate perpendicularly to its own longitudinal axis. In an embodiment in which the filter column has an attachment point for a rotating axis situated in the horizontal line of symmetry, the direction of flow in the column can be reversed at the same time as a certain stirring/loosening of the material can be achieved in the filter bed.

According to the concept of the invention, a geological mineral can accordingly be used for adsorption of metals from aquatic media. Depending on the metal content of the aquatic media, the filter columns are filled with different types of minerals. Wollastonite (CaSiO₃) has for example been shown remove Cu (up to 25000 μgr/L), Al (up to 5000 μgr/L), Pb (up to 3000 μgr/L), Zn (up to 1000 μgr/L), Fe (up to 1000 μgr/L). Magnesite (MgCO₃), and in particular dead burnt magnesite (MgO) has been shown to be very efficient for adsorption of Mn (up to 1600 μgr/L), Co (up to 300 μgr/L), Cu (up to 40000 μgr/L) Al (up to 3000 μgr/L), Pb (up to 3000 μgr/L), Zn (up to 3000 μgr/L), Fe (up to 1000 μgr/L).

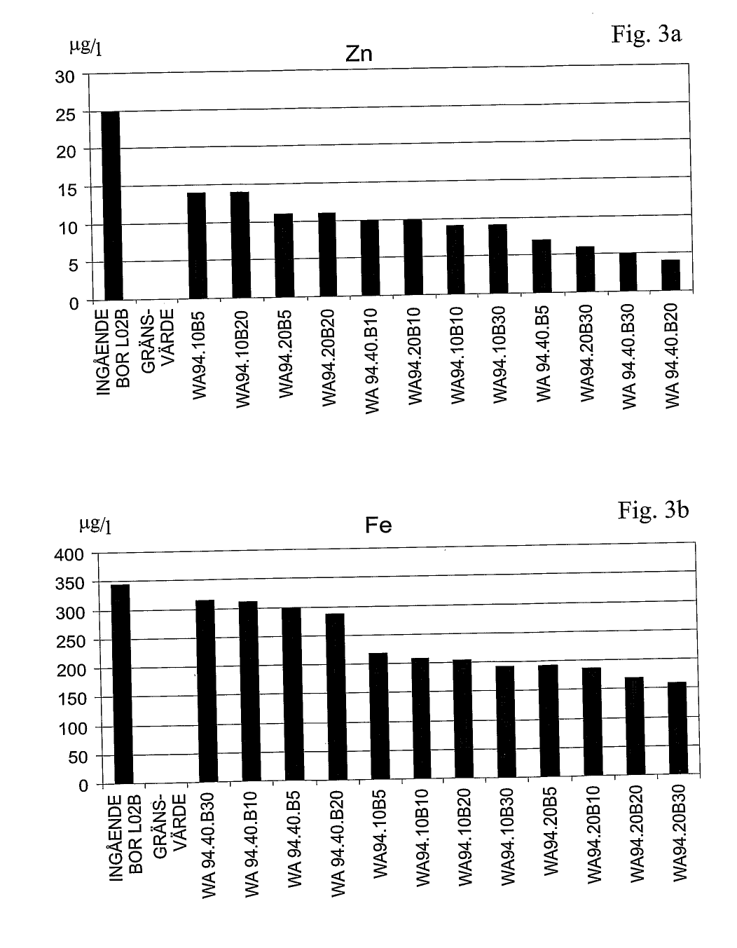

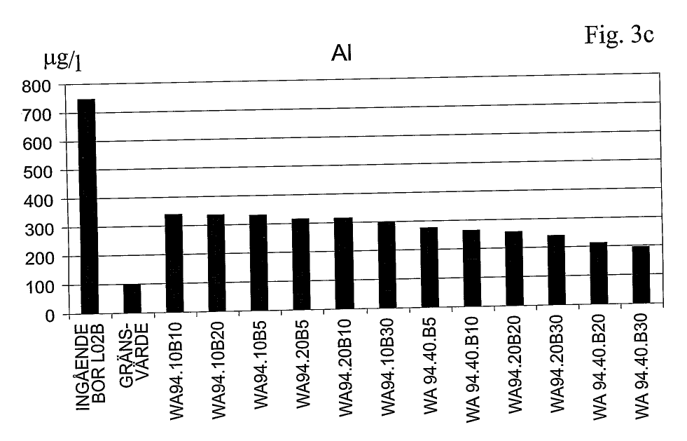

In respect of wollastonite, two types have been used for comparative studies. Coarse-grained Wollastonite type A, from the occurrence Amanda in eastern Värmland, is associated primarily with very large brown crystals of garnet and is very efficient in removing the metals, and Wollastonite type B, from the Hulta mines, which is very fine-grained, also removes the metals very efficiently. For simplicity, the diagrams in FIGS. 3a-c to 7a-c only show the results for wollastonite type A.

What is so special about these types of wollastonite is that they have been concentrated by crushing followed by milling and shake sieving, all in a dry state. Commercially, this is usually made in a wet state. The shake sieving has led to the concentrating of long and thin wollastonite crystals in the finest fractions, while the associated granular minerals such as garnet and vesuvianite remain in the more coarse fractions. A relative concentrating will accordingly give about 80% by weight in the finer fractions (63-125 μm). The other minerals that amount to about 20% by weight are left in the fractions since they seem to catalyse the adsorption.

Also in respect of magnesite, comparative studies have been made for different types, magnesite type A and magnesite type B, respectively. Magnesite type A has been used in its “raw” form, i.e. MgCO₃, and in its dead burnt form, i.e. MgO. Magnesite type A was concentrated by crushing it to 2 cm, followed by milling to 63-2000 μm, and shake sieving. All these steps took place in a dry state, i.e. without any liquid contact. The burning of magnesite A was made at a temperature of at least 1000° C., suitably about 1100° C., for about 2 hours, but it is likely that the time could be shortened. Hereby, the maximum content of CO₂, 52%, could be removed from the carbonate structure in the raw magnesite. Then, the burnt mineral was shake sieved in order to remove the finest fraction, <63 μm. Magnesite type B has only been used in its dead burnt form and is a commercially burnt magnesite. Magnesite B has been concentrated by the applicant by crushing, milling and shake sieving, in the dry state. Magnesite type A was more pure than magnesite type B, and proved to have better adsorptive ability.

Wollastonite, magnesite, and in particular dead burnt magnesite, have proven to have superior adsorptive abilities compared to other silica or carbonate minerals, such as olivine or dolomite. According to the concept of the invention, the filter mass should hence contain one or some of these minerals at a total content of at least 10% by weight, preferably at least 20% by weight, and even more preferred at least 30% by weight. During the tests made, the filter mass has consisted of geological minerals at contents of between 80 and 100%, which has resulted in a fast physical reaction, which could be an advantage. It might however be that it is more advantageous to have a filter mass that does not result in a quite so fast reaction, which means that the applicant intends to continue the experiments in order to optimize the process. It is also conceivable for the minerals to have a mutual proportion in relation to an average metal content of the liquid the metal content of which it is desired to reduce. Since the concept of the invention also includes re-use of the adsorption material in a process for acid neutralisation, it is however an advantage if the process for metal adsorption and/or the equipment is/are designed such that the minerals are kept separate from each other. This is to facilitate the subsequent neutralisation of acid, and the recovery of the residual products.

The dwell time for the aquatic medium together with the filter mass varies depending on the metal load. Experiments in laboratory scale as well as field tests have shown that dwell times of between 5 and 30 minutes seem to be adequate, but the person skilled in the art will realise that the invention is not limited thereto but that the dwell time will have to be adapted depending on the circumstances in question, such as metal content, mineral fraction and flow conditions. It also seems likely that the adsorptive capacity of the mineral will decrease when a certain amount of metals have been adsorbed, but this has hitherto not been verified in the experiments made. Therefore, the applicant will perform long time tests in order to try to saturate the filter mass.

The Process for Acid Neutralisation

When the adsorption material has fulfilled its task in the first adsorption step, it can be taken care of for re-use as a neutralising agent in an acid neutralisation step. The sulphuric acid has a pH of about −2 and is to 99% supersaturated in iron, which means that it is no longer active as a pickling bath, a so called spent pickling bath acid. Depending on its origin, it may have a somewhat varying composition. An amount in the magnitude of 200-600 g of concentrated industrial minerals in the form of MgCO₃ or MgO, is used per litre of concentrated sulphuric acid. In order to activate this acid and to make it react with the industrial minerals in the adsorption material, it is diluted with water, but it is realised that a less concentrated acid not necessarily needs to be diluted.

The acid and the adsorption materials are brought in contact with each other, whereby neutralisation of the acid is achieved at the same time as the adsorption material is being dissolved. The metals in the adsorption material are released from the adsorption material and can e.g. be concentrated in the liquid or in one or more of the reaction products formed, from which it will be possible to recover them by different means. The acid can be a metal loaded waste acid, and the metals can be concentrated by a method according to the invention in order to be recovered together with the metals from the adsorption material.

In a preferred embodiment of the invention, the acid neutralisation is performed in a thermal water bath of stainless steel at a temperature of about 80° C., but the invention is not limited thereto but can be performed at other conditions known to the person skilled in the art. It is also realised that the neutralisation process can be performed batchwise or continuously, and that the course of reaction and the process equipment should be adapted thereto.

In a batchwise embodiment of the invention, the course of reaction can be described according to the following: The adsorption material and the acid are supplied to a reaction vessel, whereby at least a part of said acid is brought in direct contact with said adsorption material. The adsorption material and/or said metal content in the adsorption material is/are dissolved during simultaneous neutralisation of the acid, whereby one or more reaction products are formed between the acid and the adsorption material. The metals adsorbed in the adsorption material are being concentrated in the liquid and/or in one or more of the reaction products.

In case the adsorption material contains magnesite, it can be used in the neutralisation of sulphuric acid according to the following reaction formula:

MgCO₃+H₂SO₄→Mg²⁺+SO₄²⁻+CO₂+H₂O

Hereby, the pH is raised considerably, the acid is neutralised. Hereby, a supersaturated solution of magnesium sulphate can be obtained, which at evaporation results in ample crystallisation of hexahydrite, a hydrated form of magnesium sulphate, as well as a smaller amount or iron sulphate:

MgSO₄.6H₂O, and (Fe,Mg)SO₄.4H₂O

When burnt magnesite type A or type B is used:

MgO+H₂SO₄→Mg²⁺+SO₄²⁻+H₂O

Hereby, the pH is raised considerably, the acid is neutralised. Hereby, a supersaturated solution of magnesium sulphate can be obtained, which at evaporation results in ample crystallisation of hexahydrite, a hydrated form of magnesium sulphate, as well as a smaller amount or iron sulphate:

MgSO₄.6H₂O, and (Fe,Mg)SO₄.4H₂O

In case the adsorption material contains wollastonite; it can be used in the neutralisation of sulphuric acid according to the following reaction formula:

CaSiO₃+H₂SO₄+3H₂O→CaSO₄.2H₂O+H₄SiO₄

The heavy metals adsorbed in the adsorption material are being concentrated in the liquid, from which recovery in the form of e.g. hydroxides will be possible. By filter pressing the formed cake of silica (H₄SiO₄), a pure silica product can be obtained according to the following reaction formula:

H₄SiO₄→SiO₂+2H₂O

By the two process steps above, the heavy metals have been concentrated in a residual solution and valuable silica has been formed.

It is also possible to use an adsorption material containing wollastonite, for neutralisation of hydrochloric acid that could be by heavy metals contaminated hydrochloric acid from spent pickling baths. A calcium chloride solution is formed according to the following reaction formula:

CaSiO₃+2HCl+H₂O→CaCl₂+H₄SiO₄

By filter pressing the cake of silica (H₄SiO₄), a pure silica product can be obtained according to the following reaction formula:

H₄SiO₄→SiO₂+2H₂O

By the two process steps above, the heavy metals have been concentrated in a residual solution and valuable silica has been formed.

The filtrate containing CaCl₂, which is obtained in the neutralisation according to the above, can then be mixed with sulphuric acid in order to regenerate hydrochloric acid and neutralise sulphuric acid according to the following reaction:

CaCl₂+H₂SO₄→CaSO₄.2HCl

Undertaken Experiments

Metal Adsorption, Initial Laboratory Tests

150 simple adsorption experiments have been made with the mineral wollastonite as adsorption medium for various solutions having varying contents of metal. The tests have been performed with the following variables:
1. varying amounts of wollastonite 5, 10, 20, 30 g/L solution
2. different fractions, 0.5-1 mm, 0.25-0.5 mm, 125-250 μm, 63-125 μm and smaller than 63 μm
3. different solutions with varying metal contents
4. different adsorption times 5, 10, 20, 30 min

The adsorption experiments were made in room temperature with 100 ml of the metal-containing solution in a beaker with magnetic stirring. Wollastonite was added and after a fixed time of adsorption, the wollastonite was filtered by filter paper and a funnel. The metal content in the respective solution, before and after the adsorption experiment, was determined by IPC spectrometric analysis and ICP-MS analysis.

The diagrams in FIGS. 3a-c, 4a-c, 5a-c, 6a-b and 7a-c show the results from the adsorption tests for two fractions of wollastonite, 125-250 μm (median=188 μm), 63-125 μm (median=94 μm). All tests were based on natural leachates from the following places in mid-Sweden:

Bortangruvan, Zn, Fe, Al (FIG. 3a-c)

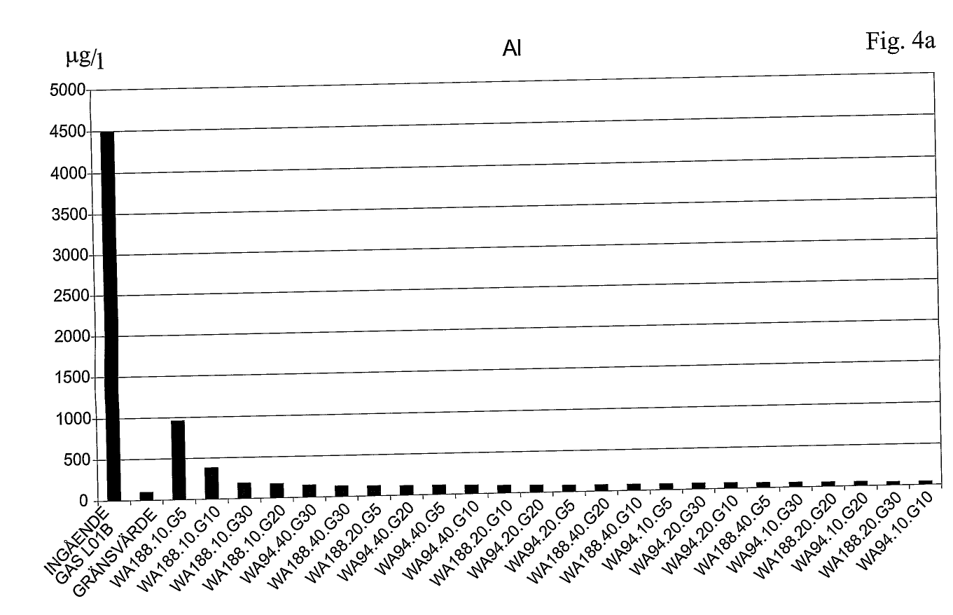

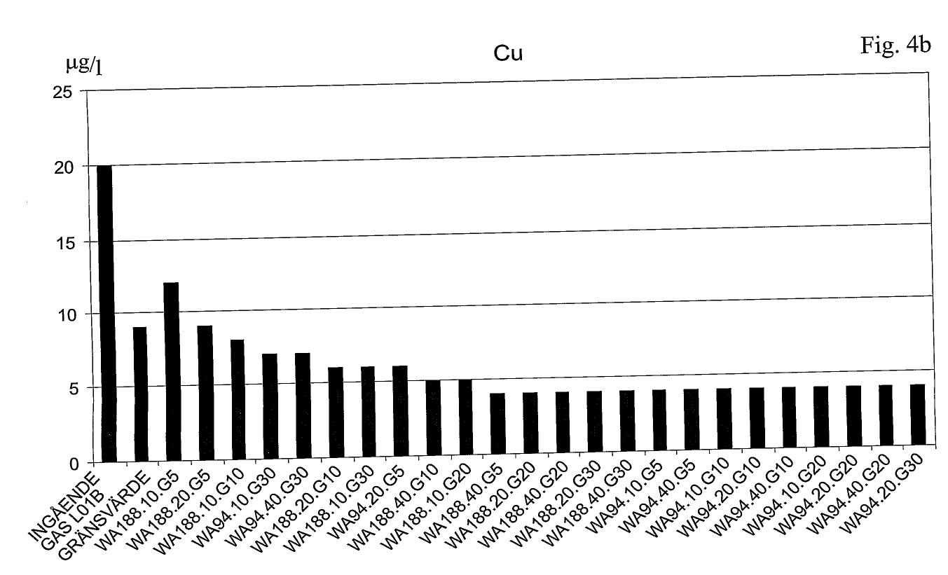

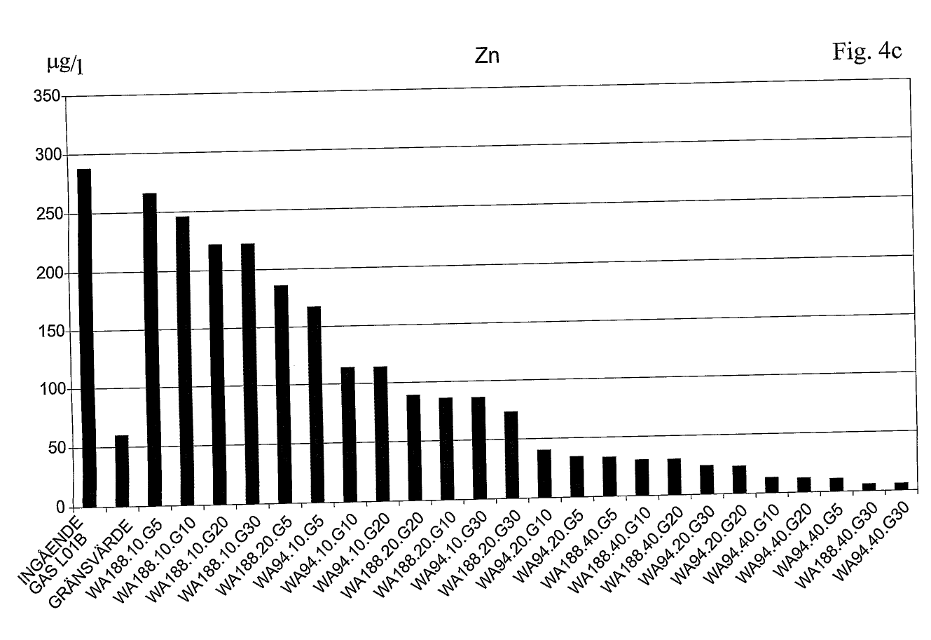

Gåsbom: Al, Cu, Zn (FIG. 4a-c)

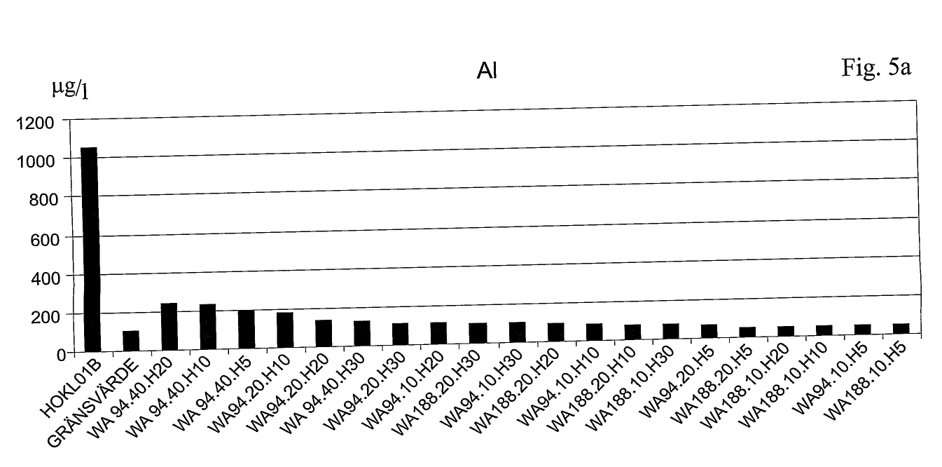

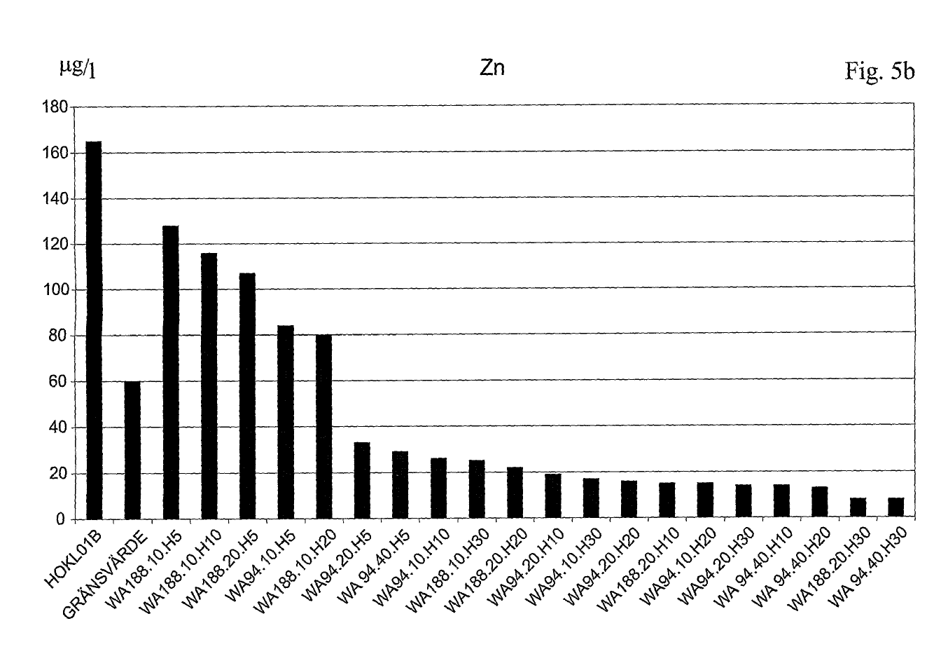

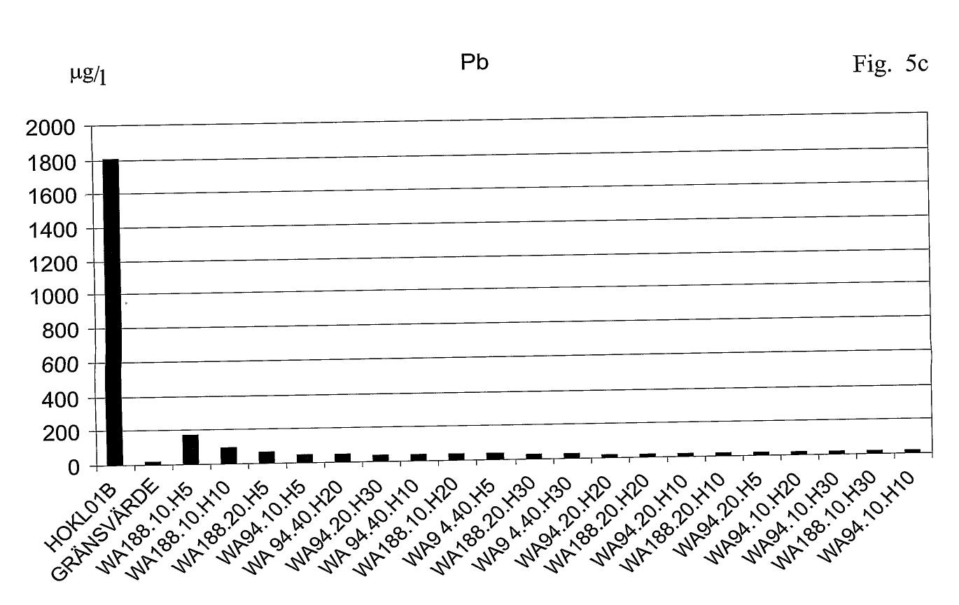

Hornkullen: Al, Zn, Pb (FIG. 5a-c)

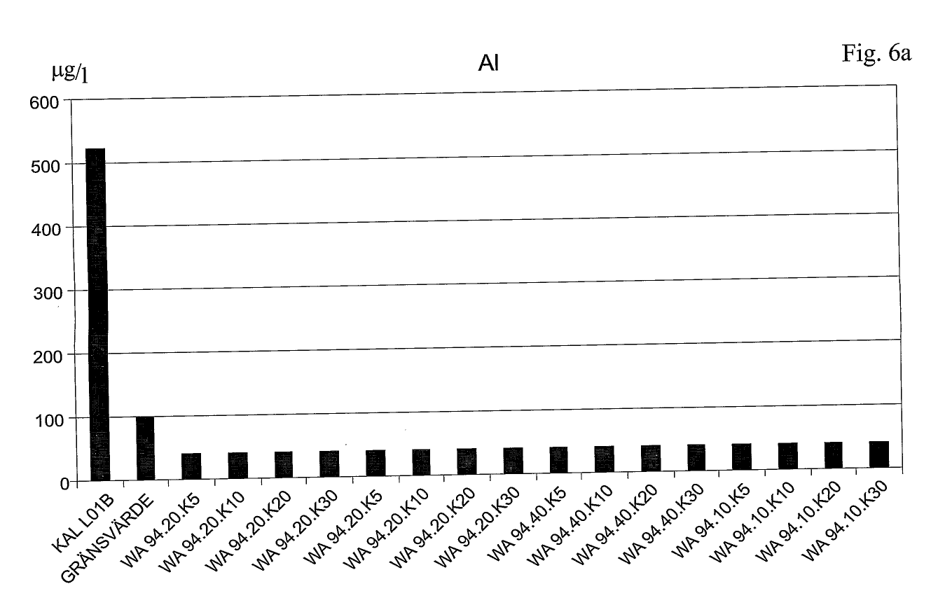

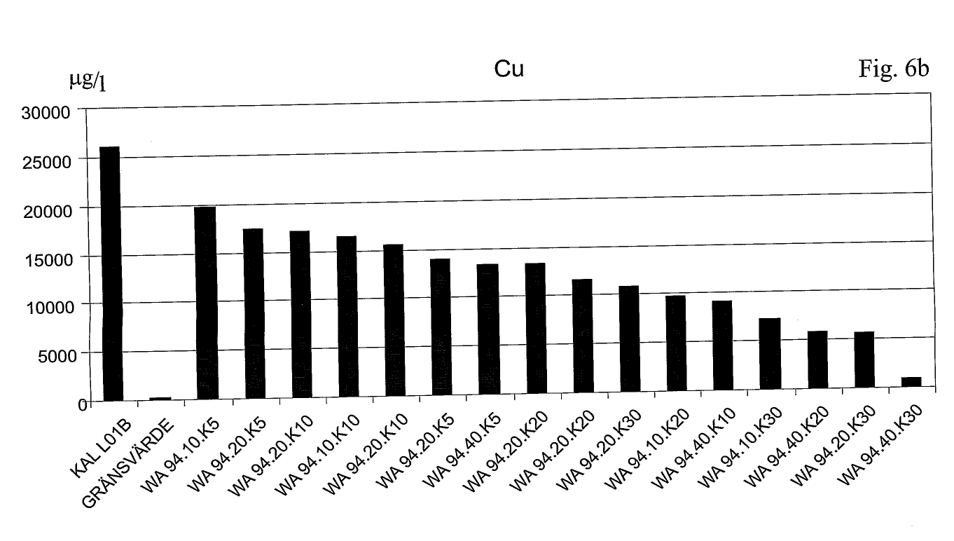

Källargruvan: Al, Cu (FIG. 6a-b)

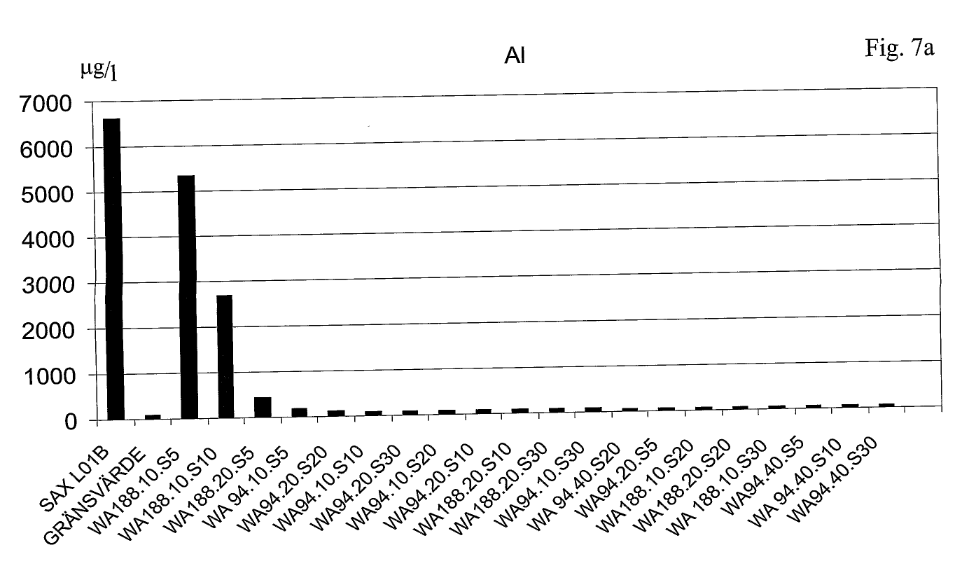

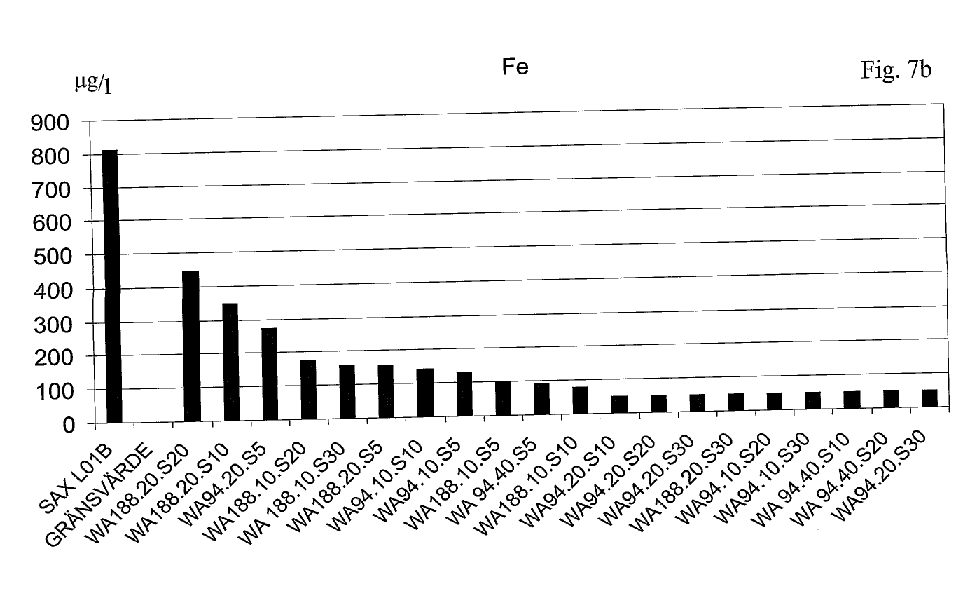

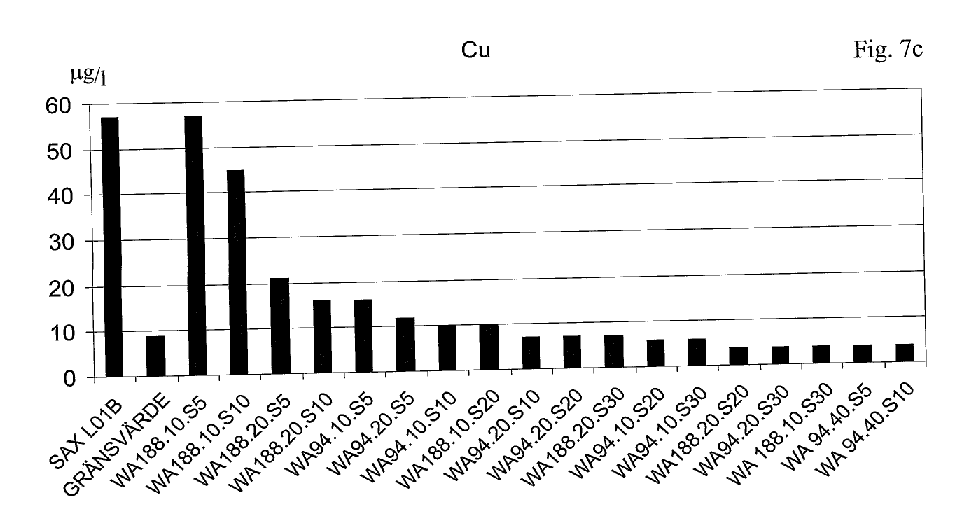

Saxån: Al, Fe, Cu (FIG. 7a-c)

The key for interpretation of the results is according to the following system:

WA118.10G5 where WA=wollastonit from the occurrence in Amanda
188=fraction 125-250 μm
10=10 g adsorption mineral/L metal-containing liquid
G=Gåsborn
5=reaction time 5 min

In the diagrams, the first column represents the content of the respective metals in the incoming leachate. The second column represents the limit value for natural water in case the limit value is lower than the content measured in the incoming leachate. The other columns represent the contents of the respective metals after the adsorption experiment.

From the diagrams it is clear that most metals can be efficiently removed by wollastonite in the fraction 63-125 μm. It is furthermore clear that the adsorption increases with an increased adsorption time, and that generally a larger amount of minerals will result in more adsorption. A preliminary conclusion from these initial laboratory tests is that:
aluminium and lead can be removed after 15 min reaction time
Iron, cobalt, zinc, yttrium, lanthanum can be removed after 20 min reaction time
Copper can be removed after 5-30 min, depending on incoming contents

A pH-increasing effect on the used leachate was also noted in the tests, which is an additional advantage. The original pH value varied between 3.5 and 6 in the incoming leachates, and during the adsorption experiments an increase in pH of between 1 and 3 units was noted.

Metal Adsorption, Comparative Tests with Wollastonite, Magnesite and Burnt Magnesite

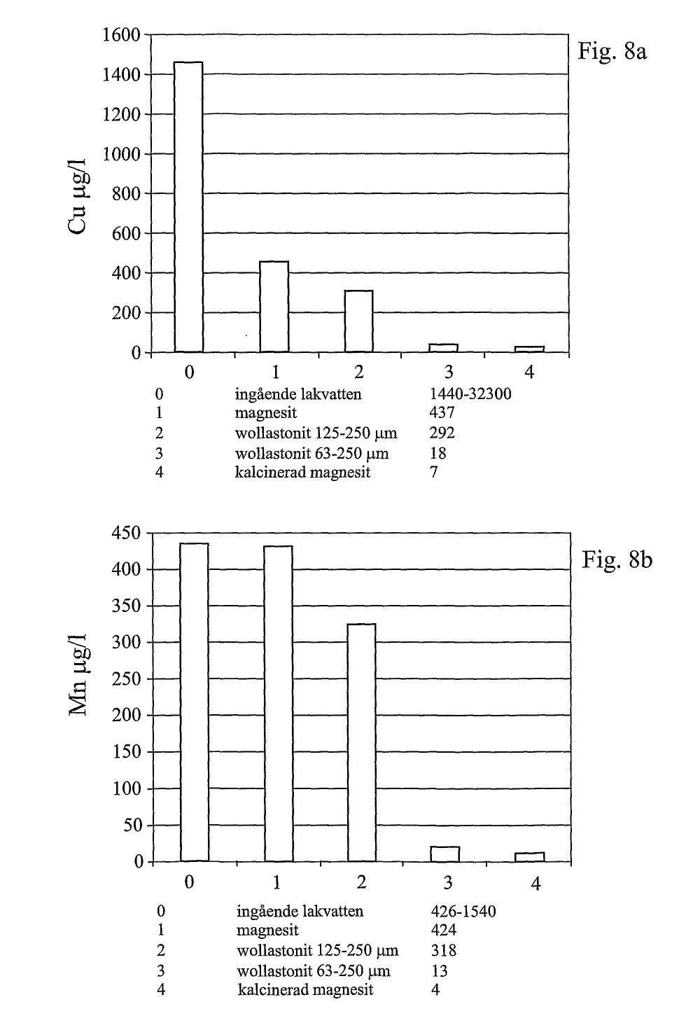

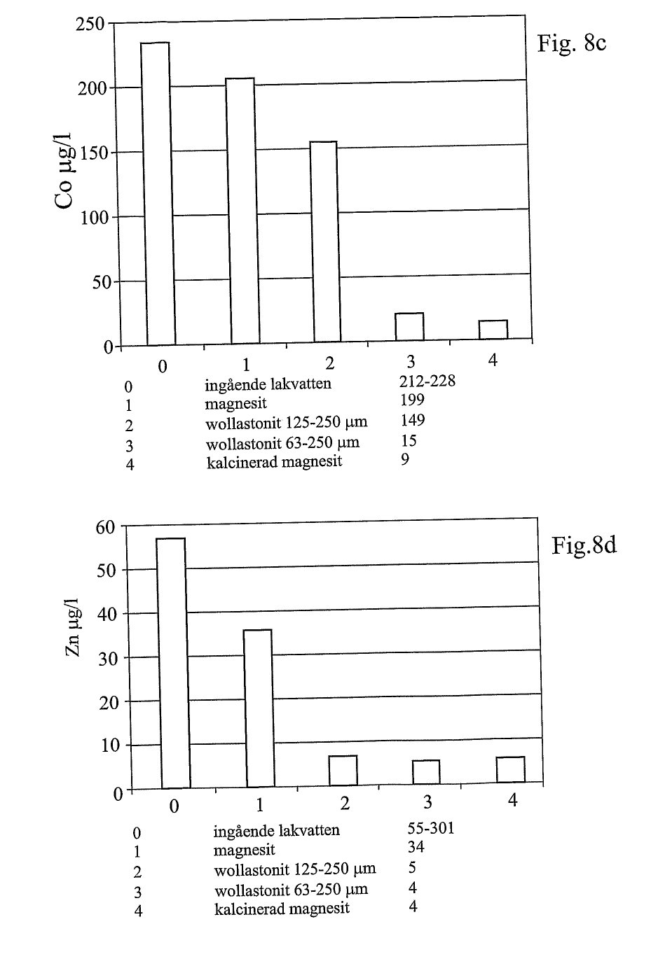

Magnesite and wollastonite of the fraction 125-250 μm, and wollastonite of the fraction 63-250 μm, were used in a study that was comparative with the adsorption capacity of the burnt magnesite. A natural leachate from Källargruvan was used as incoming water. It proved that burnt magnesite has an adsorption capacity that is superior to the other industrial mineral species. The results are presented in the diagrams and in the associated tables in FIGS. 8a-d.

It is clear from FIG. 8a that burnt magnesite removes 1433 μg/L or 99.5% of an incoming copper concentration of 1440 μg/L. The result is about the same for manganese (FIG. 8), cobalt (FIG. 8c) and zinc (FIG. 8d), of which 99.1%, 96.0% and 92.7%, respectively, are removed (FIGS. 8b, 8c, 8d).

Somewhat lower adsorption values were noted in the tests for nickel and cadmium, but this is likely due to low initial contents. The nickel and cadmium concentrations in the leachate are “only” 14 μg/L, with about 36% adsorbed by burnt magnesite. Other experiments with considerably higher incoming values for nickel, cadmium and iron have however shown adsorption coefficients of between 85 and 99%.

Metal Adsorption, Field Test 1

The method according to the invention was field tested for two days by means of a prototype for water purification according to the invention. The prototype consisted of three water tanks connected in series and having two intermediate filter columns for the geological mineral (column A and B, respectively). The filter columns were of the type described with reference to FIG. 2a. In total 615 L process water from a steel industry, containing inter alia considerable amounts of zinc and iron, was filtered through the prototype for water purification, in different rounds. Continuous measurements of the contents of these metals were made on the incoming as well as on the output water.

The tests made use of various geological minerals as adsorption materials. These were dead burnt magnesite and wollastonite, and were used according to the following protocol.

Field test 1, round 1

| Column | mineral | amount | Fraction |
|---|---|---|---|
| A bottom layer | Dead burnt magnesite | 7 kg | 0-0.5 mm |
| A top layer | Dead burnt magnesite | 1 kg | 0.5-1 mm |
| B bottom layer | Dead burnt magnesite | 7 kg | 0-0.5 mm |
| B top layer | Dead burnt magnesite | 1 kg | 0.5-1 mm |

Field test 1, round 2

| Column | mineral | amount | | fraction | |
|---|---|---|---|---|---|
| A bottom layer | wollastonite | 2 | kg | 63-125 | μm |
| A top layer | wollastonite | 4 | kg | 125-250 | μm |
| B | Dead burnt magnesite | 5.5 | kg | 0-0.5 | mm |

In round 1, column A and B were each filled with 7 kg dead burnt magnesite having a grain size in the bottom of 0.5 mm at the most and 1 kg dead burnt magnesite having a grain size of 0.5-1 mm in a layer on top of that. In total 510 L of process water was filtered during continuous flow control, measurement of pH and analysis of the contents of Ca, Mg, Zn and Fe. The dead burnt magnesite efficiently adsorbed iron and zinc. To a certain extent, the varying degrees of adsorption can be explained by variations in flow within the scope of the object of the test. In addition it was noted that the purified process water had been supplemented by the beneficial and wholesome minerals calcium and magnesium. The supplement of calcium increases somewhat over time, while the supplement of magnesium on the other hand is initially high in order then to decrease and level out over time. The levels varied over the test period within the range of 1000-27000 μg/L for calcium and 1000-29000 μg/L magnesium.

In test round 2, column A was filled with 2 kg wollastonite having a grain size of 0.063-0.125 mm in the bottom and 4 kg wollastonite having a grain size of 0.125-0.250 mm in a layer on top of that. Column B was filled with 5.5 kg magnesite having a grain size of 0-0.5 mm. Continuous flow control, measurement of pH and analysis of the contents of Ca, Mg, Zn and Fe were performed. In this test, inadequate filtering through column A was noted, which means that the test was interrupted after passage of only 105 L of process water through column A. This water was brought to pass also column.

A very important and marked decrease of the concentrations of the heavy metals Fe and Zn was noted after passage of the filter mass by the process water. The adsorption coefficient, i.e. the percentage of heavy metals removed by the industrial mineral, varies between 94.1 and 99.8%, with an average of 99.5%.

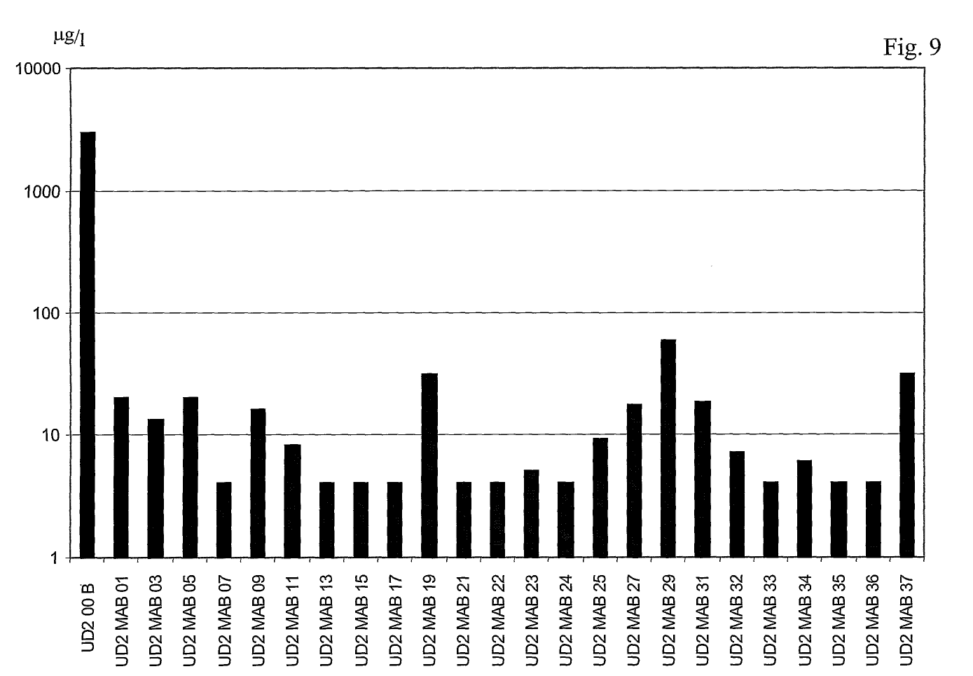

A third test round was made in order to find out whether the adsorption coefficient decreases over time and in order thereby to determine how much water and metals that can pass the filter mass with essentially maintained functionality. In the test, both columns were filled with dead burnt magnesite. The results, which are shown in the diagram in FIG. 9, show a maintained adsorption capability, with adsorption coefficients for zinc of between 99.3 and 99.9%, despite the fact that 1500 L of process water had passed through the filter. The applicant plans continued long time tests in order to optimise the process and thereby to be able to make commercial calculations for various metals.

In the field tests, a pH increase of between 1.5 and 4 units was noted in the filtered process water. This increase in pH was mainly obtained already after filtering in column A. It was furthermore noticed that wollastonite did not have a pH-increasing effect that was as large as the one for dead burnt magnesite. An additional positive effect of the method according to the invention was noted in the field tests, namely that the filtered process water was supplemented also with significant amounts of calcium and magnesium. These elements are considered to be beneficial for health as well as for environment. All in all, the filtering process can accordingly be considered to be very valuable from an environmental point of view, due to the efficient metal adsorption, the pH-increasing effect and the supplement of the beneficial elements magnesium and calcium to the process water.

Metal Adsorption, Field Test 2

The filter mass according to the invention was tested in a commercial scale, which filter mass consisted of dead burnt magnesite for purification of by chromium contaminated process water from a steel industry. After 5 days of continuous operation, the filter mass was analysed and compared with fresh filter mass. The analysis showed that a concentration had been effected in the filter mass, of calcium, potassium, phosphorus and chromium. Potassium and phosphorus are however only present at contents of hundredths of percents, and have no major effect on the system as a whole. As to chromium, it was noted that it had been concentrated in the filter mass in the form of Cr₂O₃. Besides these changes in chemical composition, there was also noted inter alia an increase of calcium in the form of CaO, and a decrease of aluminium in the form of Al₂O₃ as well as of iron in the form of Fe₂O₃.

Summary

Metal Adsorption

By a number of tests, the applicant has shown that it is possible by a method according to the invention and an adsorption material according to the invention, to efficiently adsorb metals from liquids. By the method, a large portion of the metals content is adsorbed and the concentrations thereof can be decreased as desired or, alternatively, such that the liquid passes the limits established by the National Environmental Protection agency, without risking environmental disturbances. The method according to the invention may also contribute to supplement the purified liquid with elements (Ca, Mg) from the geological filter mass, which elements may even be considered to be promoting both to human health and to nature.

Acid Neutralisation

Depending which mineral the filter mass contains, the following reaction products are obtained, which as such may constitute commercially valuable products:

| Type of material | By-products |
|---|---|
| Wollastonite | SiO₂ (silica) + gypsum |
| Magnesite (MgCO₃) | Mg sulphate + Fe sulphate |
| Calcined/dead burnt Magnesite (MgO) | Mg sulphate + Fe sulphate |

The metals originating from the adsorption material, and the residual acid, are being concentrated in the liquid solution. If desired, they can be recovered by different means.

### ALTERNATIVE EMBODIMENTS

The invention also relates to an embodiment in which the filter mass can consist of a mixture of adsorption material and other material(s). The reason for this can be to improve the flow properties or to achieve other beneficial conditions, such as in the described example with crystals of garnet as ballast in wollastonite, which seems to catalyse the reaction. As the concept of the invention also comprises re-use of the adsorption agent in a process for neutralisation of acid, it is realised that it is desirable for the ballast material to be a material that does not have any considerable negative effect on the subsequent process for neutralisation of acid, unless a separation of the adsorption material, from the ballast material, is made beforehand.

1-19. (canceled)

20. A method for adsorption of metal ions in an aquatic liquid, comprising the following process steps:
a) providing an aquatic medium containing particles, atoms and/or ions of at least one metal, light metal and/or heavy metal;
b) providing an adsorption material in the form of a geological mineral containing at least one alkali metal and/or an alkaline earth metal;
c) providing a first container comprising at least one liquid inlet;
d) arranging said adsorption material in said container to form a first filter bed comprising said adsorption material;
e) supplying said liquid to the container such that at least a portion of said liquid is brought in direct contact with said adsorption material, whereby at least a part of the content of said alkali metal and/or alkaline earth metal in the adsorption material is dissolved in said liquid;
f) removing said liquid from the container, whereby said metal particles, atoms and/or ions in the aquatic medium are at least partly adsorbed by the adsorption material;
g) mixing an acid and said adsorption material, whereby at least a portion of said acid is brought in direct contact with said adsorption material, wherein said acid is a metal loaded residual/waste acid, and in that at least a part of the adsorption material and of said metal content in the adsorption material becoming dissolved in said acid while neutralising the acid and forming one or more reaction products between the acid and the adsorption material, the metals adsorbed in the adsorption material and the metals in the acid being concentrated in one or more of the reaction products.

21. A method according to claim 20, wherein said particles, atoms and/or ions are one or more of the alkali metals and/or alkaline earth metals and/or metals and/or heavy metals that are found among the elements denoted with the atomic numbers 3-83 in the periodic system.

22. A method according to claim 20, wherein said particles, atoms and/or ions are one or more of the alkali metals and/or alkaline earth metals and/or metals and/or heavy metals that are found among the elements denoted with the atomic numbers 11-50 and 82.

23. A method according to claim 20, wherein said geological mineral is wollastonite, (CaSiO₃), and that it removes one or more of the metals Fe, Cu, Al, Mn, Co, Pb, As, Cd, Cr, Ni and/or Zn in said liquid by an adsorption degree of at least 25%, preferably at least 50%, and even more preferably at least 75% of the total metal content.

24. A method according to claim 20, wherein said geological mineral is magnesite, (MgCO₃), and that it removes one or more of the metals Fe, Cu, Al₅ Pb, Co, Mn, As, Cd, Cr, Ni and/or Zn in said liquid by an adsorption degree of at least 50%, preferably at least 80%, and even more preferably at least 90% of the total metal content.

25. A method according to claim 20, wherein said geological mineral is calcined magnesite, (MgO), and that it removes one or more of the metals Fe, Cu, Al, Pb, Co, Mn, As, Cd, Cr, Ni and/or Zn in said liquid by an adsorption degree of at least 50%, preferably at least 80%, and even more preferred at least 90% of the total metal content.

26. A method according to claim 20, wherein the geological mineral has a particle size of at least 50 μm, preferably at least 63 μm, and at the most of 5000 μm, preferably not more than 2000 μm.

27. A method according to claim 20, wherein the container also comprises an outlet for the liquid, in order to achieve a continuous flow of liquid through the adsorption material.

28. A method according to claim 20, wherein a second filter bed is arranged in a second container that is connected in series with said first container.

29. A method according to claim 20, wherein method leads to an increase of pH of between 1 and 3 pH units in the aquatic liquid.

30. A method according to claim 20, wherein the method comprises recovery of the reaction products and of the concentrated metals.

31. A method according to claim 30, wherein said acid is sulphuric acid and/or hydrochloric acid.

32. A method according to claim 31, wherein said acid originates from spent pickling baths.

33. An metal adsorption material comprising at least one geological mineral, wherein said geological material is a silicate or a carbonate containing at least one alkali metal and/or an alkaline earth metal, and that said geological mineral has been concentrated by crushing, milling and shake sieving in a dry state.

34. An adsorption material according to claim 33, wherein said alkali metal and/or alkaline earth metal is calcium and/or magnesium, and that it has a grain size of at least 50 μm, preferably at least 63 μm, and at the most of 5000 μm, preferably not more than 2000 μm.

35. An adsorption material according to claim 33, further comprising at least partly composed of wollastonite (CaSiO₃) having a grain size of 50-5000 μm, preferably 125-2000 μm, for adsorption of metal ions of Fe, Cu, Al₅ Mn, Co, Pb, As, Cd, Cr, Ni and/or Zn possibly present in the liquid.

36. An adsorption material according to claim 33, further comprising at least partly composed of magnesite (MgCO₃) having a grain size of 50-5000 μm, preferably 63-2000 μm, for adsorption of metal ions of Fe, Cu, Al, Mn, Co, Pb, As, Cd, Cr, Ni and/or Zn possibly present in the liquid.

37. An adsorption material according to claim 33, further comprising at least partly composed of calcined (dead burnt) magnesite (MgO) having a grain size of 50-5000 μm, preferably 63-2000 μm, for adsorption of metal ions of Fe, Cu, Al₅ Mn₅ Co₅ Pb, As, Cd, Cr, Ni and/or Zn possibly present in the liquid.

38. An adsorption material according to claim 33, further comprising one or some of said geological minerals at a total content of at least 10% by weight, preferably at least 20% by weight, and even more preferred at least 30% by weight.

39. An adsorption material according to claim 38, wherein the minerals have mutual proportions in relation to an average metal content of the liquid the metal content of which it is desired to reduce.
